(19) United States
(12) Patent Application Publication
(10) Pub. No.: US 2009/0288300 A1
(43) Pub. Date: Nov. 26, 2009

(54) SHEAR ASSEMBLY

(76) Inventor: Warren D. Gregory, JR., Sidney, IA (US)

Correspondence Address: HOLLAND & HART, LLP, P.O BOX 8749, DENVER, CO, 80201, US

(21) Appl. No.: 12/126,541

(22) Filed: May 23, 2008

(51) Int. Cl. B25F 5/00

(52) U.S. Cl. 30/134; 180/313

(57) ABSTRACT

A shear assembly is presented for use with different types of motorized vehicles and is generally provided with an upper cutting jaw, a lower receiving jaw having an open pocket, and an insert disposed within the open pocket. The insert is positioned to engage a cutting edge of the upper jaw when the jaw is in a closed position. In some embodiments, the insert is comprised of a material that permits the insert to yield to the cutting edge of the lower jaw when the cutting edge engages the insert.

### BACKGROUND

Various shear attachments have been developed over the years for use with wheeled vehicles, such as skid loaders, tractors and the like. A common design of this type of shear positions a single blade within an upper jaw that is pivotably coupled with a fixed lower jaw. One or more actuators are coupled with the upper jaw to move the upper jaw between open and closed positions with respect to the lower jaw in a scissor-like motion. In some designs, the lower jaw is provided in the form of a pair of opposing, vertically oriented plates that are positioned in a spaced-apart relationship with one another to leave an open space between the plates. In this orientation, the cutting edge of the blade is allowed to extend into the open space between the plates of the lower jaw when the shear is placed in a closed position. Accordingly, rigid objects that are positioned against the lower jaw are cleanly cut as the blade passes beyond the upper edge of the lower jaw plates. The open space in the lower jaw is frequently designed to pass completely through the lower jaw so that debris is allowed to pass through the lower jaw as materials are cut by the shear. After a brief period of operation, this area between the lower jaw plates becomes lodged with debris. Frequently, the debris will slowly feed through the lower jaw opening, with each subsequent closing cycle of the blade, as additional debris is forced into the opening. However, the debris compresses between the frames with each subsequent cut, causing a considerable outward force on the lower jaw plates. Moreover, if the shear goes unused for an extended period of time, the debris will harden to the point that it will cause a blockage that can no longer be forced through the lower jaw by continued cutting operations. The only positive consequence of foreign material between the lower jaw plates is that flexible, small diameter objects, such as sapling trees can be cut, as the small trees are backed by the foreign material, instead of bending into the opening between the shear frame plates.

Other shear designs include a steel plate welded within the opening between the lower jaw plates so that foreign material will not enter and become lodged between the lower jaw plates. This means that the blade must stop at a precise point just before it is forced against the steel plate. If the blade stops too early, the shear will make incomplete cuts. If the cutting edge of the blade is forced against the steel plate, damage will likely occur to the blade, the steel plate, or other components of the shear. However, the requirement for such precision causes continued problems over time. As the blade is sharpened, blade material is removed and the blade becomes increasingly shallow. This prevents the cutting edge from traveling to the required depth when the blade is cycled to its closed position. Rather, then the blade is in the closed position, a gap will remain between the cutting edge and the steel plate. Each subsequent sharpening will cause the size of the gap to increase, degrading the performance of the shear. To compensate, an operator must typically perform a complicated and time consuming blade adjusting procedure, if the shear is capable of adjustment. However, most shear designs do not permit such adjustments, requiring the operator to replace the blade.

Other manufactures have attempted to correct the deficiencies of the aforementioned shears by welding a steel plate between the lower jaw plates below the upper edge of the lower jaw plates. Accordingly, the blade is allowed to over-travel the upper edge portion of the lower jaw plates. This permits an operator to repeatedly sharpen the cutting edge without decreasing the ability of the shear to completely cut through objects. However, this design results in severe debris compaction between the lower jaw plates due to the fact that the debris becomes trapped within the pocket between the steel plate and the lower jaw plates. The debris will continue to build until the blade is prevented from closing fully, requiring the operator to stop and remove the compacted material from the lower jaw.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

A shear assembly, according to the present technology, is generally provided with an upper jaw and a lower jaw that are pivotably coupled with one another and movable between open and closed positions with respect to one another. A mounting bracket may be associated with the shear assembly so that the shear assembly may be operatively coupled with one of various platforms that may include motorized vehicles, such as loaders and the like. One or more actuators may be associated with the upper jaw to enable a user to selectively move the shear assembly between various open and closed positions.

In some embodiments, the upper jaw is provided with a cutting edge that is formed at least partially along a lower side portion of the upper jaw. Various embodiments of the embodiment provide the lower jaw with an open pocket adjacent an upper edge portion of the lower jaw. The open pocket may be shaped to receive at least a portion of the cutting edge of the upper jaw when the shear is in a closed position. Some embodiments of the shear include an insert that is shaped to be removably disposed within the open pocket of the lower jaw. In some aspects, the insert is positioned to engage the cutting edge of the upper jaw when the shear is in a closed position.

In various embodiments, the insert may be comprised of a material that permits the insert to yield to the cutting edge of the upper jaw when the cutting edge engages the insert. In some embodiments, the insert is formed from a plastic composite material. The insert may be positioned within the shear so that, as the shear is moved into a closed position, debris is substantially prevented from entering the open pocket of the lower jaw. In some embodiments, the insert is provided to be removably coupled with the lower jaw. This may enable replacement of the insert and servicing the shear assembly with relative ease.

Some embodiments of the shear are provided with an elongated support member, having a channel that extends along a length of the support member. In such embodiments, the support is shaped to approximate a shape of the open pocket of the lower jaw. At least a portion of the insert may be shaped to approximate a shape of the channel of the support member to provide a secure engagement between the structures. In some embodiments, one or more fasteners are transversely disposed through one side of the lower jaw, the insert, and a second side of the lower jaw. In these embodiments, the one or more fasteners may be selectively tightened to urge the first and second sides of the lower jaw toward one another.

These and other aspects of the present system and method will be apparent after consideration of the Detailed Description and Figures herein.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a perspective view of one embodiment of the shear assembly as it may be coupled with a mobile platform, such as a skid-steer loader.

FIG. 2 depicts a partial, exploded view of one embodiment of the shear assembly.

FIG. 3 depicts a side elevation view of one embodiment of the shear assembly as it may be placed in an open position.

FIG. 4 depicts a side elevation view of the shear assembly of FIG. 3 as it may be placed in a closed position.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

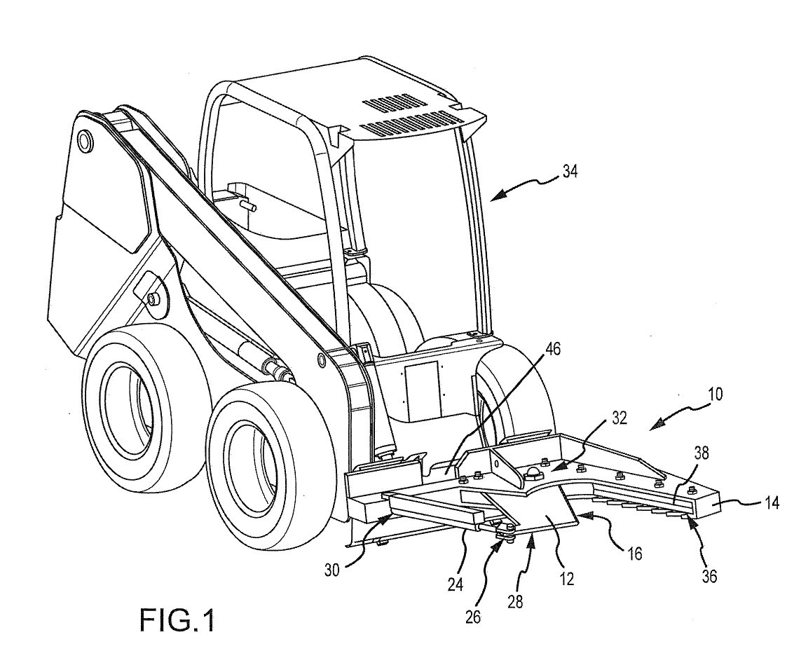

The numeral 10 refers generally to the shear assembly of the present invention, as the same is generally depicted in FIGS. 1-4. It will be apparent to those skilled in the art that the shear assembly 10 of the present invention is well suited for a plurality of tasks including the felling, sizing and pruning of timber, brush and other vegetation. However, it should also be apparent that other non-organic material, such as scrap metal, plastic and the like could be cut using the present invention. It should also be understood that the shear is easily adapted for use as an attachment for a plurality of motorized vehicles, including front-end loaders, skid loaders, tractors, backhoes, excavators and end loaders. However, the examples described herein should not be considered to be limiting, as the uses and applications of the present invention are limited only by the imagination of the user. For simplicity of description, the shear assembly of the present invention will be described as it could be used on skid loaders to fell or prune timber and brush.

The shear assembly 10 is generally provided with an elongated upper jaw 12 and a generally angular lower jaw 14, each having rearward and forward end portions. “Upper” and “lower” are used herein to generally differentiate the jaws 12 and 14 and facilitate the ease of describing the shear assembly 10 only. Due to the variable positioning of the shear assembly 10, “upper” and “lower” are not to be construed as definitive descriptions of the orientation of the jaws 12 and 14 with respect to the horizontal. Upper jaw 12 is shaped to have a cutting edge 16 along its lower side portion. In some embodiments, the lower jaw 14 is comprised of a pair of jaw plates 18 and 20 that are positioned in a spaced relationship with one another to form an open pocket 21 for at least partially receiving the cutting edge 16 of upper jaw 12. In various embodiments, the pocket 21 may extend from the upper edge portion of the lower jaw 14 through a lower edge portion of the lower jaw 14. However, other embodiments may enclose the lower portion of the lower jaw 14 so that the pocket 21 is otherwise enclosed, but for an open upper end portion.

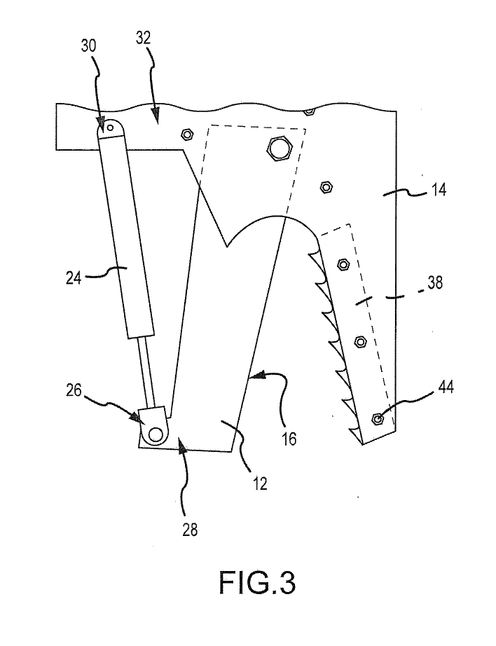

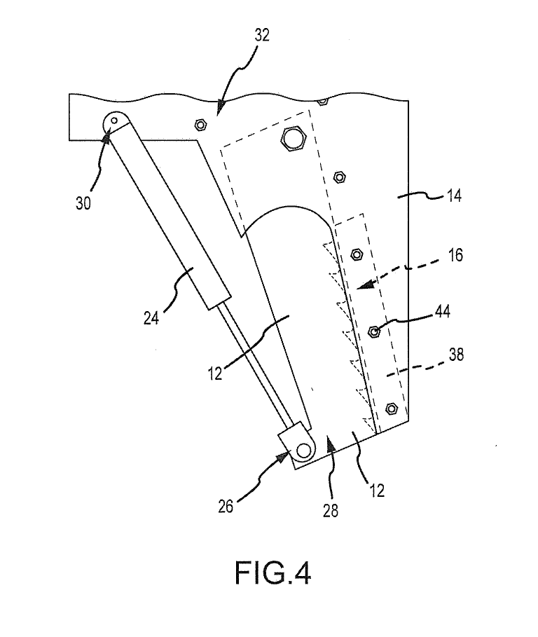

The upper and lower jaws are provided to move with respect to one another between open and closed positions. In some embodiments, the jaws are pivotably connected to each other at the rearward ends thereof. While it is contemplated that many pivoting joints known in the art could be used, one preferred assembly comprises a high strength sleeve and shaft assembly 22, which is operatively coupled to the rearward end portions of the upper and lower jaws 12 and 14. One or more actuators 24 can be used to move the upper jaw 12 between open and closed positions with respect to the lower jaw 14. In some embodiments, such as depicted in FIGS. 3 and 4, a single actuator 24 may be used effectively. A first end 26 of the actuator 24 is pivotably connected to a forward end portion 28 of the upper jaw 12. The second end 30 of the actuator 24 is operatively connected to a rearward end portion 32 of the lower jaw 14. The actuator may be operatively coupled to the vehicle 34 and the operational controls thereof.

In various embodiments, the lower jaw 14 may be provided with a cutting edge engagement portion 36. Some embodiments of the cutting edge engagement portion 36 may include an insert 38 that is disposed within the open pocket 21 of the lower jaw 14 and positioned to engage the cutting edge 16 of the upper jaw 12 when said shear 10 is in a closed position. In one aspect, the insert 38 is comprised of a material that permits the insert 38 to yield to the cutting edge 16 of said upper jaw 12 when the cutting edge 16 engages the insert 38. In some exemplary embodiments, the insert 38 may be formed from a composite material. An example of such a material may include a plastic composite that is commonly used in fabricating recycled, plastic lumber, which is typically used in home patio or deck construction. It is contemplated, however, that there other materials, which exhibit similar structural properties, that could be used to form the insert 38. Regardless of the specific materials used to fabricate the insert 38, it is shaped to substantially prevent debris from entering the open pocket 21 of the lower jaw 13, from the upper edge portion of the lower jaw 14. The insert 38 is generally provided with a blade engagement face 40 that is positioned closely adjacent the upper edge portion of the lower jaw 14. In some embodiments, blade engagement face 40 extends from the first side member to the second side member of the lower jaw 14. In this manner, debris freely falls from the edges of the lower jaw 14 when materials are cut with the shear 10.

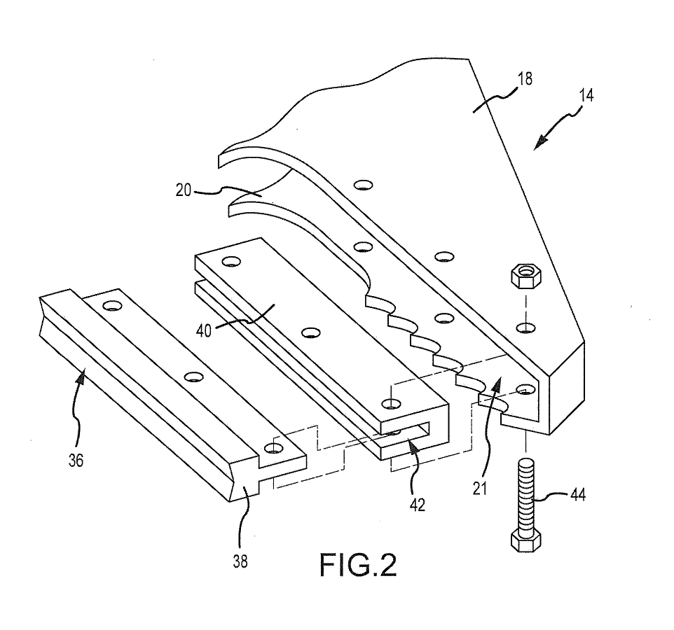

With reference to FIG. 2, the insert 38 may be contained on three or more sides by an elongated support member 40, having a channel 42 that extends along a length of the support member 40. In some embodiments, the channel 42 may be shaped to provide the support member 40 with a generally U-shaped cross-section. The support member 40 will also have a shape that approximates a shape of the pocket 21 of the lower jaw 14. In this manner, the support member 40 may be removed from and installed within the pocket 21 with relative ease while providing a snug fit. At least a portion of the insert 38 may be shaped to approximate the shape of the channel 42 of the support member 40. As with the fit of the channel 40 with respect to the pocket 21, the appropriate shaping of the channel 42 and portions of the insert 38 permit a snug, removable engagement between the structures. In some embodiments, such as depicted in FIG. 2, the insert 38 is formed to have a generally T-shaped cross-section, an upper portion of the T-shaped cross section includes a blade engagement face and a lower portion of the T-shaped cross section being shaped to fit within the channel 42 of the support member 40. In some aspects, the support member 40 prevents the force imposed by the upper jaw 12 from pushing the deformable, composite material of the insert 38 out the back side of the frame, where the back side of the lower jaw 14 is provided to be open.

In some embodiments, one or more fasteners 44, which may be moved between tightened and loosened positions, are transversely disposed through the jaw plates 18 and 20 of the lower jaw 14 in a manner that urges the jaw plates 18 and 20 toward one another, when the one or more fasteners 23 are tightened, and permit the jaw plates 18 and 20 to move away from one another slightly when the one or more fasteners 23 are loosened. In one aspect, a plurality of fasteners 23 are positioned along a long axis of the lower jaw 14, intermediate the upper and lower edge portions thereof, as depicted in FIGS. 2, 3 and 4. In some embodiments that incorporate the use of an insert 38 and, optionally a support member 40, openings may be formed through the support member 40 and the insert 38 to accommodate the fasteners 44. Accordingly, the fasteners may further serve to secure the insert 38 and the support member 40 in position when the shear assembly 10 is in use. It is contemplated that various embodiments, different variations of fasteners could be used, such as the bolts and nuts depicted. It is also contemplated that sleeves may be disposed around the fasteners 44, between the jaw plates 18 and 20, to protect the fasteners 40.

The shear assembly 10 is easily attached to a plurality of different motorized vehicles, including front-end loaders, skid loaders, tractors, backhoes, excavators or end loaders, by means of a mounting bracket 46. In order to attach the shear assembly 10 to different vehicles, it is preferred that the mounting bracket 46 be comprised of a universal two-pin, quick-attach hitch. However, it is contemplated that other mounting assemblies would appropriately secure the shear assembly 10 to the vehicle 34. Such mounting bracket assemblies typically operate with one or more actuators on the vehicle 34 to pitch the mounting bracket 46 up and down with respect to the operating surface.

In some embodiments, the rearward end portion of the lower jaw 14 is coupled to the mounting bracket 46 so that it may be selectively rotated about an axis extending generally perpendicularly from the mounting bracket 46. In this manner, the shear can be rotated so that it may be operated in a generally horizontal position, as depicted in FIG. 1, or a generally vertical position, as generally depicted in FIGS. 3 and 4. It is contemplated that the shear can be pivoted to nearly any degree of rotation to accommodate the circumstances presented in a cutting operation. At least one actuator couples the rearward end portion of the lower jaw 14 to the mounting bracket 46 to assist the operator in rotation of the shear.

The central components of the shear assembly 10, such as the upper and lower jaws 12 and 14, may be manufactured from numerous materials that are durable and have sufficient strength for the contemplated uses. One preferred embodiment of the shear assembly 10 is constructed from high-strength steel, such as ASTM-A-572 Grade 50 High Tensile Plate, or its approximate equivalent. The plate steel provides benefits beyond that of strength. The plate steel provides ease of manufacture. The upper and lower jaws 12 and 14, mounting brackets and bracing members, can all be cut from a single plate of steel without the need of further processing and manufacturing. Accordingly, the total cost of manufacture can be decreased. Moreover, the plate steel permits the cutting edge 16 of the upper jaw to be easily formed through flame cutting or similar process and then ground to provide an optimum cutting edge. In the event the cutting edge is blemished during future use, it can be easily sharpened on location with a simple hand grinder.

In operation, the shear assembly 10 may be used to cut irregularly shaped objects comprised of a wide range of materials. The shear 10 is particularly well suited for felling, sizing and pruning trees and brush. For example, the operator can position the lower shear assembly 10 closely adjacent to a limb of a tree at nearly any angle and at various heights above ground. Upon the initial closing cycle of the shear 10, the blade engagement face of the insert 38 is cut a little as the cutting edge of the upper jaw 12 over-travels the upper most portions of the lower jaw 14. The use of a deformable, but generally resilient, material to construct the insert 38 will permit the cut formed by the cutting edge 16 to close at least partially. In this manner, debris is substantially prevented from entering the cut. It is contemplated that once the initial cut is made in the insert 38, little, if any, additional damage or deterioration to the insert 38 will be caused by the immediate continued use of the shear assembly 10. However, replacement of the insert 38 over time is anticipated and the manner in which it engages the lower jaw 14 makes replacement a relatively quick and simple task.

The insert 38 inhibits foreign material from entering the pocket 21, which can become difficult to dislodge over time. The insert 38 also allows the upper jaw 12 to cut small flexible sections such as sapling trees that would otherwise deflect and bend into the pocket 21 of the lower jaw 14. Another benefit realized from the use of the insert 38 is that the insert 38 allows for over-travel of the cutting edge 16. This virtually eliminates the need for precise cutting edge adjustments and also allowing for future blade sharpening without the need for adjustment or blade replacement.

Although the system has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. In combination:
a motorized vehicle; and
a shear, operatively coupled with said motorized vehicle, comprising:
an upper jaw having forward and rearward end portions, upper and lower side portions, and a cutting edge formed at least partially along said lower side portion;
a lower jaw having forward and rearward end portions and an upper edge portion; said rearward end portion of said lower jaw being operatively pivotably coupled to the rearward end portion of said upper jaw so that said shear may be selectively moved between open and closed positions; said lower jaw being comprised of first and second side members that are laterally spaced from one another to define an open pocket in the upper edge portion of said lower jaw that is shaped and sized to receive at least a portion of the cutting edge of said upper jaw when said shear is in said closed position;
an insert disposed within the open pocket of said lower jaw and positioned to engage the cutting edge of said upper jaw when said shear is in said closed position; said insert being comprised of a material that permits said insert to yield to the cutting edge of said upper jaw when the cutting edge engages said insert;
at least one actuator operatively coupled with said upper jaw to selectively move said shear between said open and closed positions; and
a mounting bracket operatively coupling said shear with said motorized vehicle.

2. The combination of claim 1 wherein said insert is shaped to substantially prevent debris from entering the open pocket of said lower jaw from the upper edge portion of said lower jaw.

3. The combination of claim 2 wherein said insert is provided with a blade engagement face that is positioned closely adjacent the upper edge portion of said lower jaw.

4. The combination of claim 3 wherein said blade engagement face extends from the first side member to the second side member of said lower jaw.

5. The combination of claim 1 further comprising:
an elongated support member, having a channel extending along a length of said support member that provides said support member with a generally U-shaped cross-section;
said support being shaped to approximate a shape of the open pocket of said lower jaw;
at least a portion of said insert being shaped to approximate a shape of the channel of said support member.

6. The combination of claim 5 wherein said insert is formed to have a generally T-shaped cross-section, an upper portion of said T-shaped cross section including a blade engagement face and a lower portion of said T-shaped cross section being shaped to fit within the channel of said support member.

7. The combination of claim 5 wherein said insert is comprised of a plastic composite material.

8. The combination of claim 1 further comprising at least one fastener, which may be moved between tightened and loosened positions, transversely disposed through the first side member of said lower jaw, said insert, and second side members of said lower jaw in a manner that urges said first and second side members toward one another when said at least one fastener is tightened and permit the first and second side members to move away from one another when said at least one fastener is loosened.

9. The combination of claim 8 further comprising:
an elongated support member, having a channel extending along a length of said support member that provides said support member with a generally U-shaped cross-section;
said support being sized and shaped to fit within the open pocket of said lower jaw; said insert being sized and shaped to at least partially fit within the channel of said support member.

10. The combination of claim 9 wherein said at least one fastener is provided as a plurality of fasteners, which may be moved between tightened and loosened positions.

11. The combination of claim 10 wherein each of said plurality of fasteners is comprised of a bolt and a nut.

12. The combination of claim 10 wherein said plurality of fasteners are positioned to substantially prevent the first and second side members of said lower jaw from moving away from one another and said insert from exiting the open pocket of said lower jaw when the shear is in use.

13. A shear assembly, comprising:
an upper jaw having forward and rearward end portions, upper and lower side portions, and a cutting edge formed at least partially along said lower side portion;
a lower jaw having forward and rearward end portions and a cutting edge engagement portion; said lower jaw being operatively pivotably coupled with said upper jaw so that the shear may be selectively moved between open and closed positions;
said cutting edge engagement portion being positioned to engage the cutting edge of said upper jaw when said shear is in said closed position; said cutting edge engagement portion being comprised of a material that permits said cutting edge engagement portion to yield to the cutting edge of said lower jaw when the cutting edge engages said cutting edge engagement portion;
at least one actuator operatively coupled with said upper jaw to selectively move said shear between said open and closed positions; and
a mounting bracket operatively coupling said shear with a platform.

14. The shear assembly of claim 13 wherein said cutting edge engagement portion is shaped and positioned with respect to said lower jaw to substantially prevent debris from entering an interior cavity of said lower jaw.

15. The shear assembly of claim 14 wherein at least a portion of said cutting edge engagement portion is selectively removably engagable with said lower jaw.

16. The combination of claim 15 wherein said cutting edge engagement portion is comprised of a plastic composite material.
